(19) United States
(12) Patent Application Publication
(10) Pub. No.: US 2008/0290132 A1
(43) Pub. Date: Nov. 27, 2008

(54) Main Air Valve for Pneumatic Nail Gun

(76) Inventor: Chia-Sheng Liang, Taipei Hsien (TW)

Correspondence Address: HDSL, P.O. BOX 220746, CHANTILLY, VA, 20153-0746, US

(21) Appl. No.: 11/753,558

(22) Filed: May 24, 2007

(51) Int. Cl. B25C 1/04

(52) U.S. Cl. 227/130

(57) ABSTRACT

A nail gun includes a cylinder, a main chamber, a piston slidably disposed in the cylinder, and a trigger valve disposed in the nail gun. The piston divides the cylinder into a top air chamber and a bottom air chamber, and the trigger valve can actuate the high pressure air in the main chamber to drive the main air valve to open or close the fluid communication between the main chamber and the top air chamber. A main air valve is disposed at a top portion of the cylinder, which includes a valve port, a top and bottom air tight rings disposed on the piston. The valve port is disposed between the top and bottom air tight rings when it is closed, and moves to a place away from the top air tight ring when it is opened.

### BACKGROUND

The present invention relates to main air valves for pneumatic nail guns, and particularly to a main air valve disposed at a top portion of a fixed cylinder or a moveable cylinder of a nail gun. The main air valve is capable of being driven by the high pressure air to open or close the fluid communication between the main air valve and the cylinder during the process of driving the piston to hit nails.

The related arts, such as U.S. Pat. No. 6,533,156 and U.S. Pat. No. 6,779,699, respectively disclosed a nail gun installing a main air valve and a fixed cylinder. The main air valve is separately disposed at a top portion of the fixed cylinder, and which includes a valve port disposed at the top portion of the fixed cylinder. An air tight ring or a ring-shaped rubber washer is disposed on one of the main air valve and the fixed cylinder. A trigger valve of the nail gun can actuate the high pressure air in a gun body of the nail gun to drive the main air valve to move, for opening or closing the valve port so as to guide the high pressure air into the fixed cylinder to drive the piston to move down to hit nails. However, the nail gun only uses a single air tight ring or a ring-shaped rubber washer to close the fluid communication between the valve port and the cylinder, which results in that the valve port is liable to become loose when the valve port shakes due to the nail gun encountering acutely collision. That is, the valve port has a lower reliability of closing the fluid communication of the fixed cylinder, and the high pressure air is liable to incorrectly be guided into the fixed cylinder to drive the piston to hit nails.

Other related arts, such as U.S. Pat. No. 4,784,308 and U.S. Pat. No. 4,319,705, respectively disclosed a nail gun installing a moveable cylinder and a moveable main air valve separately disposed at a top portion of the moveable cylinder. The main air valve includes a valve port disposed at the top portion of the moveable cylinder, and the main air valve can move along with the cylinder. When a trigger is pressed, the high pressure air in a main chamber of the nail gun drives the main air chamber and the cylinder to move up to open the valve port, for guiding the high pressure air into a top chamber for driving the piston to move down to hit nails. However, it also uses a single air tight ring or a ring-shaped rubber washer to close the fluid communication between the valve port of the main air valve and the cylinder, which also results in that the valve port is liable to become loose when the valve port shakes due to the nail gun encountering acutely collision. That is, this valve port also has the problem of lower reliability of closing the fluid communication of the moveable cylinder.

Accordingly, what is needed is a main air valve for pneumatic nail gun that can overcome the above-described deficiencies.

### BRIEF SUMMARY

A main air valve of a nail gun is provided. The nail gun includes a gun body having a cylinder, a main chamber, a piston slidably disposed in the cylinder, and a trigger valve disposed in the gun body. The piston divides the cylinder into a top air chamber and a bottom air chamber, and the trigger valve is capable of actuating high pressure air in the main chamber to drive the main air valve to open or close the fluid communication between the main chamber and the top air chamber.

The main air valve is disposed at a top portion of the cylinder, which includes a valve port disposed at the top portion of the cylinder, and a top air tight ring and a bottom air tight ring disposed on the piston. The valve port is disposed at a place between the top and bottom air tight rings when it is closed, for preventing the high pressure air from exhausting into the cylinder via the valve port so as to improve the reliability of air tight. The valve port moves to a place away from the top air tight ring when it is opened, for guiding the high pressure air into the top air chamber via the valve port to drive the piston with a hitting bar to move down to hit nails.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, cross-sectional view of part of a nail gun installing a main air valve according to a first embodiment of the present invention;

FIG. 2 is a cross-sectional view of the nail gun of FIG. 1, showing the nail gun in an operation state;

FIG. 3 is a cross-sectional view of the nail gun of FIG. 1, showing the nail gun in another operation state;

FIG. 4 is a schematic, cross-sectional view of part of a nail gun installing a main air valve according to a second embodiment of the present invention;

FIG. 5 is a cross-sectional view of the nail gun of FIG. 4, showing the nail gun in an operation state;

FIG. 6 is a schematic, cross-sectional view of part of a nail gun installing a main air valve according to a third embodiment of the present invention;

FIG. 7 is a cross-sectional view of the nail gun of FIG. 6, showing the nail gun in an operation state;

FIG. 8 is a schematic, cross-sectional view of part of a nail gun installing a main air valve according to a fourth embodiment of the present invention;

FIG. 9 is a cross-sectional view of the nail gun of FIG. 8, showing the nail gun in an operation state;

FIG. 10 is a schematic, cross-sectional view of part of a nail gun installing a main air valve according to a fifth embodiment of the present invention; and

FIG. 11 is a cross-sectional view of the nail gun of FIG. 10, showing the nail gun in an operation state.

### DETAILED DESCRIPTION

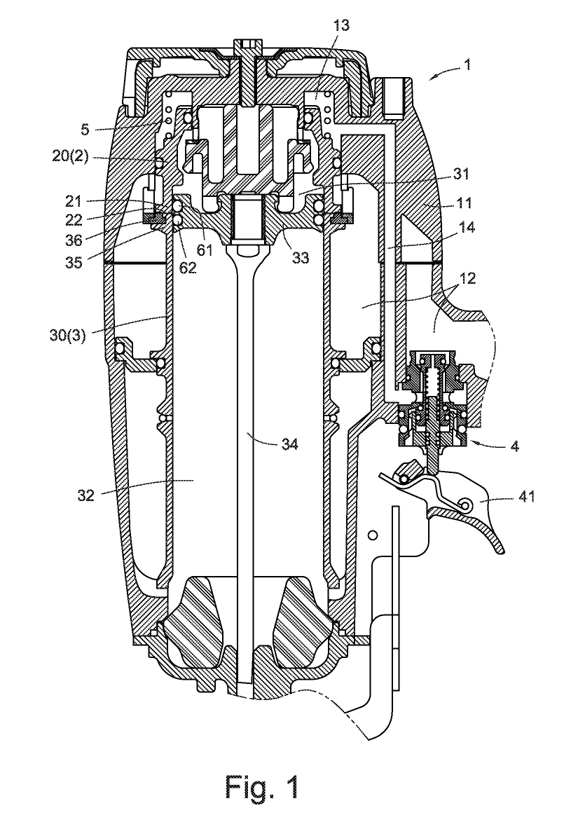

Referring to FIG. 1, a schematic, cross-sectional view of part of a nail gun installing a main air valve according to a first embodiment of the present invention is shown. The nail gun 1 includes a cylinder 30 disposed in a gun body 11 thereof, and a main air valve 20 disposed at a top portion of the cylinder 30.

In this illustrated embodiment, the main air valve 20 is a movable head valve 2, and a bottom portion of which includes a ring-shaped bottom valve surface 21. A top air collecting chamber 13 is formed between a top portion of the head valve 2 and an inner surface of the gun body 11. The cylinder 30 is a fixed type cylinder 3, and a top portion of the cylinder 3 includes a ring-shaped top valve surface 35. An air tight ring-shaped valve washer 36 is coupled to the top valve surface 35, and a piston 33 is slidably disposed in the cylinder 3. The piston 33 divides the cylinder 3 into a top air chamber 31 and a bottom air chamber 32, and the piston 33 includes a hitting bar 34 disposed at a bottom portion thereof.

The head valve 2 includes a valve port 22 disposed at a top portion of the cylinder 3, and the valve port 22 is formed between the bottom valve surface 21 of the head valve 2 and the top valve surface 35 as well as the valve washer 36 of the cylinder 3. The valve port 22 is connected between the cylinder 3 and a main chamber 12 in the gun body 11. The main chamber 12 can concentrate air and maintain a certain high pressure air therein. At the same time, a spring 5 is disposed in the top air chamber 31 for driving the head valve 2 to move down to close the valve port 22.

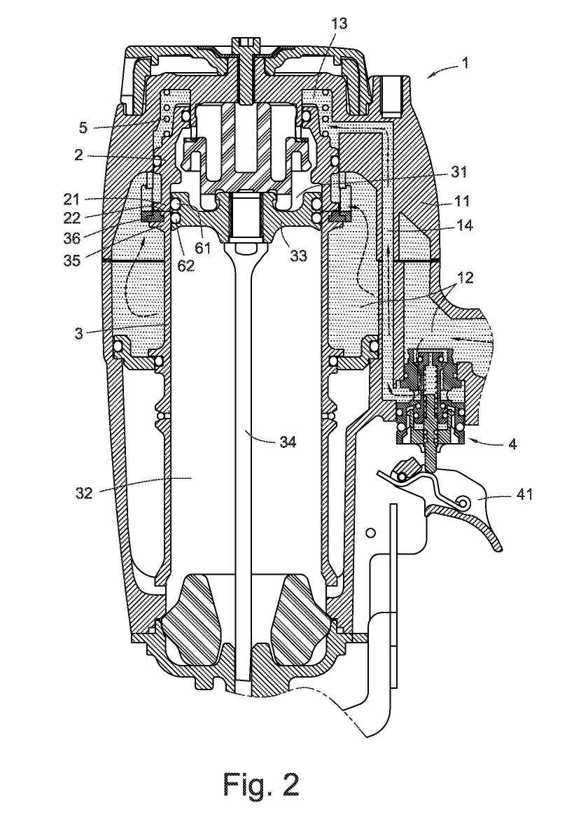

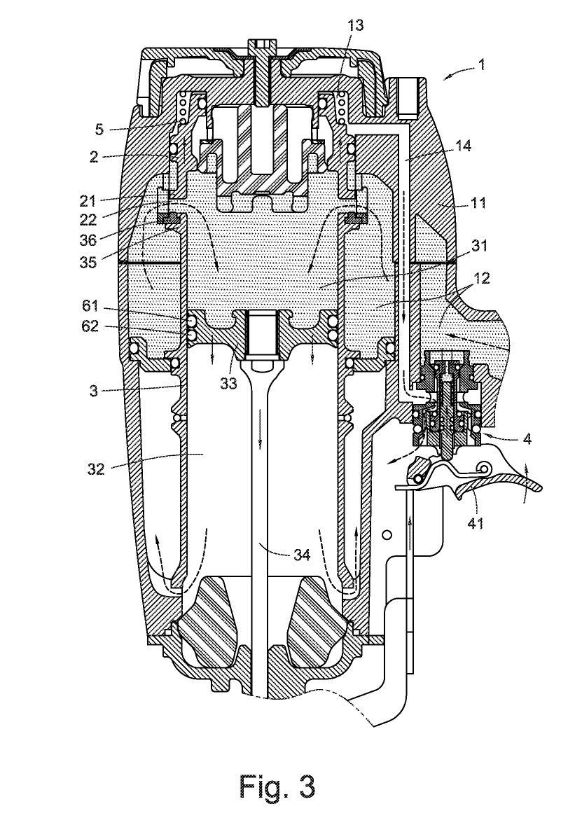

Moreover, a trigger valve 4 is disposed in the gun body 11, which is capable of guiding the high pressure air in the main chamber 12 to drive the head valve 2 to move when being actuated to be opened. The trigger valve 4 is disposed between a trigger passage 14 in the gun body 11 and the main chamber 12, and the trigger valve 4 is connected with the top air collecting chamber 13. The trigger valve 4 is capable of guiding the high pressure air in the main chamber 12 into the top air collecting chamber 13 via the trigger passage 14 when being actuated to be closed (as shown in FIG. 2), and is also capable of guiding the high pressure air in the top air collecting chamber 13 to exhaust to the external atmosphere via the trigger passage 14 and the trigger valve 4 when being actuated to be opened (as shown in FIG. 3). A trigger 41 is pivotally attached to the gun body 11, the user can press the trigger 41 to drive the trigger valve 4 to open or close.

Furthermore, a top air tight ring 61 and a bottom air tight ring 62 are separately disposed on the piston 33. The valve port 22 is at the place between the top and bottom air tight rings 61 and 62 when it is closed (as shown in FIG. 2), and the valve port 22 moves to the place away from the top air tight ring 61 when it is opened (as shown in FIG. 3).

With these configurations, the assembled nail gun 1 can be used.

In operation, before the trigger 41 is manipulated as shown in FIG. 2, the piston 33 is kept to stay at the top portion of the cylinder 3 so as to keep top portions of the top valve surface 35 and the valve washer 36 at a place between the top and bottom air tight rings 61 and 62. The high pressure air in the main chamber 12 is guided into the top air collecting chamber 13 via the trigger valve 4 and the trigger passage 14. Then the high pressure air in the top air collecting chamber 13 is cooperative with the spring 5 to drive the head valve 2 to move down, for keeping the bottom portion of the bottom valve surface 21 of the head valve 2 to move down to a top portion of the top valve surface 35 and the valve washer 36 that is at a place between the top and bottom air tight rings 61 and 62, to close the head valve 2. Then, the closed valve port 22 of the head valve 2 is kept in an air tight space between the top and bottom air tight rings 61 and 62 to prevent the high pressure air from exhausting into the cylinder 3 via the valve port 22. Particularly, the user incautiously falling down the nail gun 1 or the nail gun encountering acutely collision may lead the valve port 22 to be loose, but the high pressure air exhausting from the valve port 22 is obstructed by the top and bottom air tight rings 61 and 62. Therefore, the head valve 2 has a higher reliability of air tight.

When the trigger 41 is pressed by the user (as shown in FIG. 3), the high pressure air in the top air collecting chamber 13 is exhausted to external atmosphere via the trigger passage 14 and the trigger valve 4, to make the top portion of the head valve 2 not pressing by the high pressure air. Then the high pressure air in the main chamber 12 can drive the head valve 2 to move up, for driving the bottom valve surface 21 of the head valve 2 to move to the place away from the top air tight ring 61. The valve port 22 is opened and moves to the place away from the top air tight ring 61 for guiding the high pressure air in the main chamber 12 into the top air chamber 31 via the valve port 22 to drive the piston 33 to actuate the hitting bar 34 to move down to hit nails.

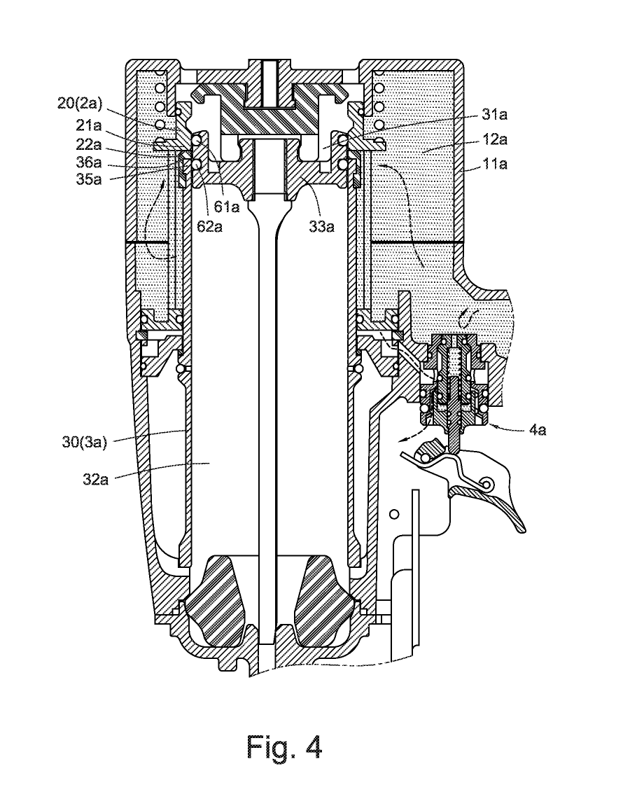

Referring to FIG. 4, a schematic, cross-sectional view of part of a nail gun installing a main air valve according to a second embodiment of the present invention is shown. In this illustrated embodiment, the main air valve 20 is a moveable valve sleeve 2a, which includes a ring-shaped bottom valve surface 21a at a bottom portion thereof. The cylinder 30 is a fixed cylinder 3a, and a top portion of the cylinder 3a includes a ring-shaped top valve surface 35a. A ring-shaped valve washer 36a is coupled to the top valve surface 35a. The valve sleeve 2a includes a valve port 22a disposed at the top portion of the cylinder 3a, and the valve port 22a is formed between the bottom valve surface 21a and the valve washer 36a. The valve port 22a is connected between the cylinder 3a and a main chamber 12a in the gun body 11a. The main chamber 12 can concentrate air and maintain a certain high pressure air therein. At the same time, a spring 5 is disposed in the main chamber 12a for driving the head valve 2 to move down to close the valve port 22a. A piston 33a is slidably disposed in the cylinder 3a, and the piston 33a divides the cylinder 3a into a top air chamber 31a and a bottom air chamber 32a. A trigger valve 4a is disposed in the gun body 11a, which is capable of guiding the high pressure air in the main chamber 12a to drive the valve sleeve 2a to close or open the valve port 22a.

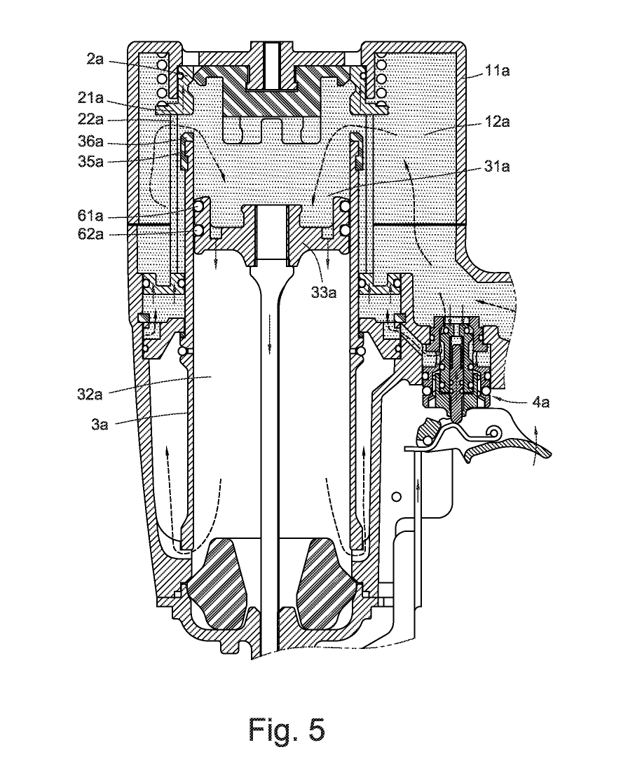

A top air tight ring 61a and a bottom air tight ring 62a are separately disposed on the piston 33a. The valve port 22a between the bottom valve surface 21a and the valve washer 36a is at the place between the top and bottom air tight rings 61a and 62a when it is closed, for preventing the high pressure air from exhausting into the cylinder 3a via the valve port 22a. Moreover, the bottom valve surface 21a can actuate the valve port 22a to move to the place away from the top air tight ring 61a to open the valve port 22a (as shown in FIG. 5), for guiding the high pressure air in the main chamber 12a into the top air chamber 31a via the valve port 22a to drive the piston 33a to move down to hit nails.

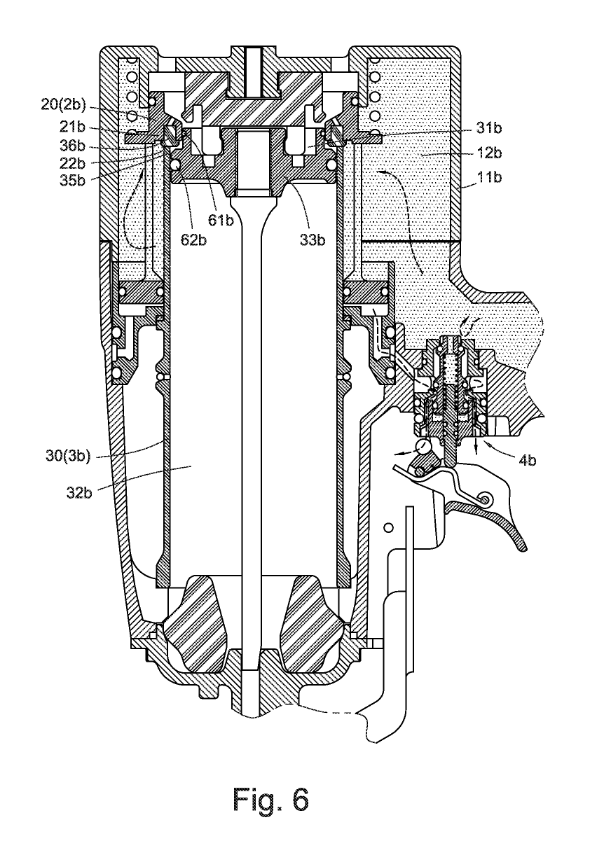

Referring to FIG. 6, a schematic, cross-sectional view of part of a nail gun installing a main air valve according to a third embodiment of the present invention is shown. In this illustrated embodiment, the main air valve 20 is a moveable valve sleeve 2b, which includes a ring-shaped bottom valve surface 21b at a bottom portion thereof. A ring-shaped valve washer 36b is coupled to a bottom portion of the bottom valve surface 21b. The cylinder 30 is a fixed cylinder 3b, and a top portion of the cylinder 3b includes a ring-shaped top valve surface 35b. The valve sleeve 2b includes a valve port 22b disposed at the top portion of the cylinder 3b, and the valve port 22b is formed between the top valve surface 35b and the valve washer 36b. The valve port 22b is connected between the cylinder 3b and a main chamber 12b in the gun body 11b. A piston 33b is slidably disposed in the cylinder 3b, and the piston 33b divides the cylinder 3b into a top air chamber 31b and a bottom air chamber 32b. A trigger valve 4b is disposed in the gun body 11b, which is capable of guiding the high pressure air in the main chamber 12b to drive the valve sleeve 2b to close or open the valve port 22b.

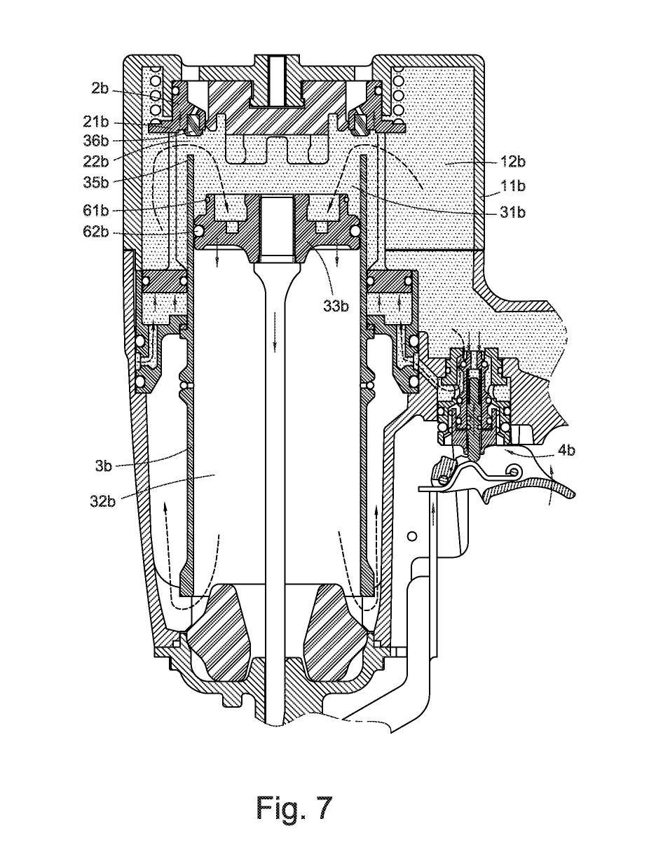

A top air tight ring 61b and a bottom air tight ring 62b are separately disposed on the piston 33b. The valve port 22b between the top valve surface 35b and the valve washer 36b is at the place between the top and bottom air tight rings 61b and 62b when it is closed, for preventing the high pressure air from exhausting into the cylinder 3b via the valve port 22b. Moreover, the ring-shaped valve washer 36b can actuate the valve port 22b to move to the place away from the top air tight ring 61b to open the valve port 22b (as shown in FIG. 7), for guiding the high pressure air in the main chamber 12b into the top air chamber 31b via the valve port 22b to drive the piston 33b to move down to hit nails.

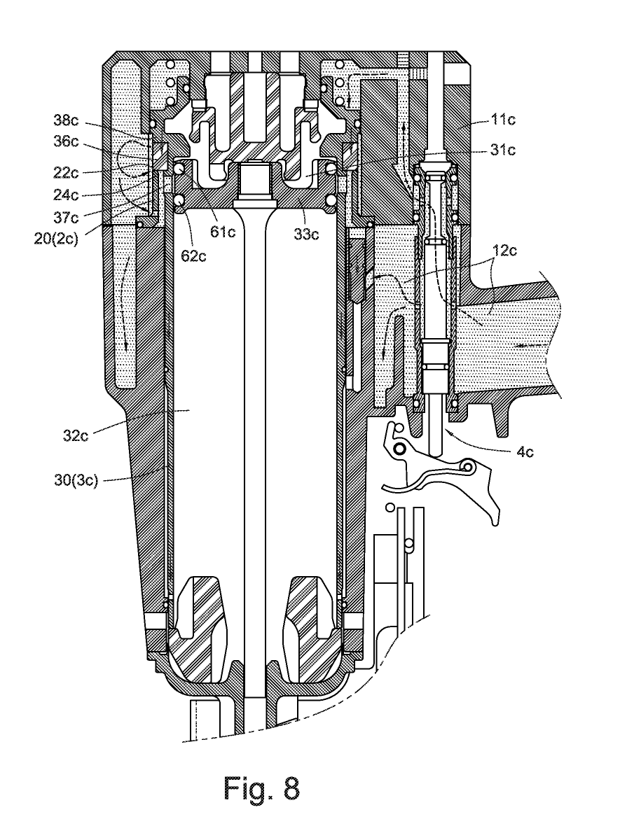

Referring to FIG. 8, a schematic, cross-sectional view of part of a nail gun installing a main air valve according to a fourth embodiment of the present invention is shown. In this illustrated embodiment, the main air valve 20 is a fixed valve sleeve 2c disposed at a top portion of the cylinder 30. The valve sleeve 2c includes a ring-shaped top valve surface 24c at a top portion thereof. The cylinder 30 is a moveable cylinder 3c, and a top portion of the cylinder 3c includes a ring-shaped bottom valve surface 38c and a plurality of air holes 37c connected with the cylinder 3c. A ring-shaped valve washer 36c is coupled to a bottom portion of the bottom valve surface 38c. The valve sleeve 2c includes a valve port 22c disposed at the top portion of the cylinder 3c, and the valve port 22c is formed between the top valve surface 24c and the valve washer 36c. The valve port 22c is connected between the air holes 37c and a main chamber 12c in the gun body 11c. A piston 33c is slidably disposed in the cylinder 3c, and the piston 33c divides the cylinder 3c into a top air chamber 31c and a bottom air chamber 32c. A trigger valve 4c is disposed in the gun body 11c, which is capable of guiding the high pressure air in the main chamber 12c to drive the cylinder 3c to move to close or open the valve port 22c.

A top air tight ring 61c and a bottom air tight ring 62c are separately disposed on the piston 33c. The valve port 22c between the top valve surface 24c and the valve washer 36c is at the place between the top and bottom air tight rings 61c and 62c when it is closed. At the same time, the cylinder 3c can also bring the air holes 37c to the place between the top and bottom air tight rings 61c and 62c when the valve port 22c is closed, for preventing the high pressure air from exhausting into the cylinder 3c via the valve port 22c and the air holes 37c.

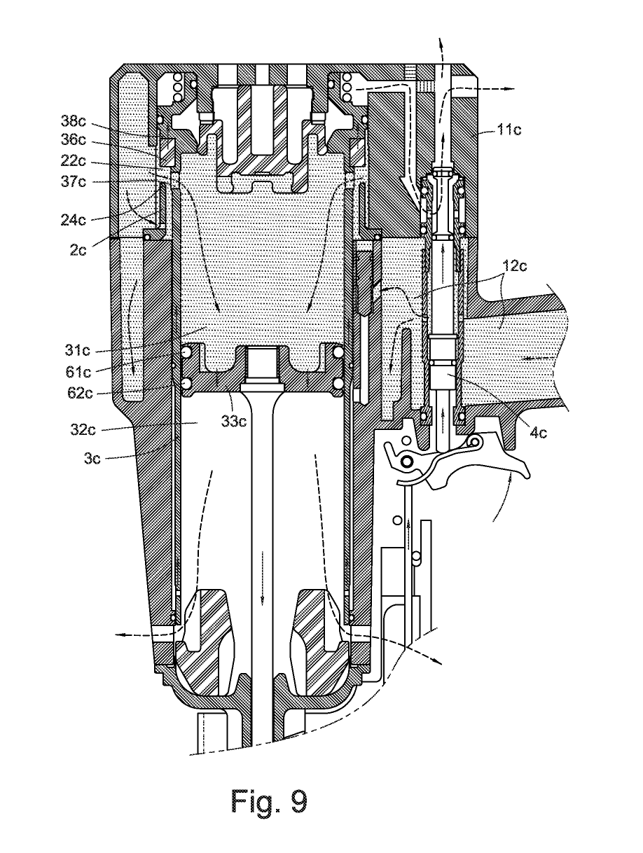

Moreover, the ring-shaped valve washer 36c can actuate the valve port 22c and the air holes 37c to move to the place away from the top air tight ring 61c to open the valve port 22c (as shown in FIG. 9), for guiding the high pressure air in the main chamber 12c into the top air chamber 31c via the valve port 22c and the air holes 37c to drive the piston 33c to move down to hit nails.

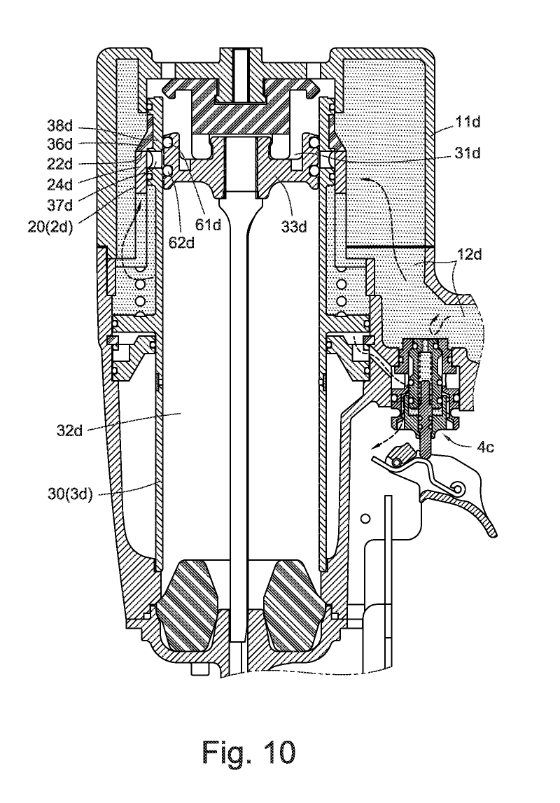

Referring to FIG. 10, a schematic, cross-sectional view of part of a nail gun installing a main air valve according to a fifth embodiment of the present invention is shown. In this illustrated embodiment, the main air valve 20 is a fixed valve sleeve 2d disposed at a top portion of the cylinder 30. The valve sleeve 2d includes a ring-shaped top valve surface 24d at a top portion thereof. The cylinder 30 is a moveable cylinder 3d, and a top portion of the cylinder 3d includes a ring-shaped bottom valve surface 38d and a plurality of air holes 37d connected with the cylinder 3d. A ring-shaped valve washer 36d is coupled to the bottom valve surface 38d. The valve sleeve 2d includes a valve port 22d disposed at the top portion of the cylinder 3d, and the valve port 22d is formed between the top valve surface 24d and the valve washer 36d. The valve port 22d is connected between the air holes 37d and a main chamber 12d in the gun body 11d. A piston 33d is slidably disposed in the cylinder 3d, and the piston 33d divides the cylinder 3d into a top air chamber 31d and a bottom air chamber 32d. A trigger valve 4d is disposed in the gun body 11d, which is capable of guiding the high pressure air in the main chamber 12d to drive the cylinder 3d to move to close or open the valve port 22d.

A top air tight ring 61d and a bottom air tight ring 62d are separately disposed on the piston 33d. The valve port 22d between the top valve surface 24d and the valve washer 36d is at the place between the top and bottom air tight rings 61d and 62d when it is closed. At the same time, the cylinder 3d can also bring the air holes 37d to the place between the top and bottom air tight rings 61d and 62d when the valve port 22d is closed, for preventing the high pressure air from exhausting into the cylinder 3d via the valve port 22d and the air holes 37d.

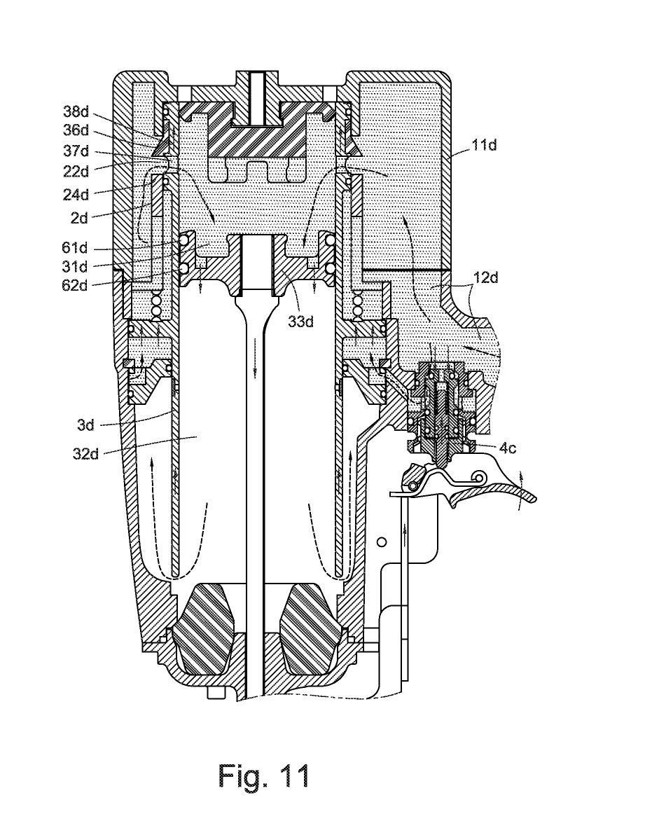

Moreover, the ring-shaped valve washer 36d can actuate the valve port 22d and the air holes 37d to move to the place away from the top air tight ring 61d to open the valve port 22d (as shown in FIG. 11), for guiding the high pressure air in the main chamber 12d into the top air chamber 31d via the valve port 22d and the air holes 37d to drive the piston 33d to move down to hit nails.

The configurations of the main air valve of the gun body are not limited to the gun bodies 11, 11a, 11b, 11c, 11d described above. The main air valve that being capable of opening and closing the valve port on the top portion of the cylinder for guiding the high pressure air in the main chamber into the top air chamber via the valve port to drive the piston to move down to hit nails can be installed in the gun body of the present invention.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A main air valve of a nail gun, the nail gun comprising a gun body having a fixed cylinder, a main chamber, a piston slidably disposed in the cylinder, and a trigger valve disposed in the gun body, the piston dividing the cylinder into a top air chamber and a bottom air chamber, the trigger valve being capable of actuating high pressure air in the main chamber to drive the main air valve to open or close fluid communication between the main chamber and the top air chamber, the main air valve being movably disposed on top of the fixed cylinder wherein:
a valve port is formed between a bottom valve surface of the main air valve and a top valve surface of the cylinder for the fluid communication being performed therethrough; and
a top air tight ring and a bottom air tight ring are disposed on the piston;
such that the piston is disposed at a place to make the valve port located between the top and the bottom air tight rings when the main air valve is driven by the high pressure air to move to close the valve port, and the piston is disposed at a place to make the valve port located away from the top air tight ring when the main air valve is driven by the high pressure air to move to open the valve port.

2. The main air valve of a nail gun as claimed in claim 1, wherein the main air valve is a head valve.

3. The main air valve of a nail gun as claimed in claim 1, wherein the main air valve is a movable valve sleeve.

4. (canceled)

5. (canceled)

6. (canceled)

7. A main air valve of a nail gun, the nail gun comprising a gun body having a movable cylinder, a main chamber, a piston slidably disposed in the cylinder, and a trigger valve disposed in the gun body, the piston dividing the cylinder into a top air chamber and a bottom air chamber, the trigger valve being capable of actuating high pressure air in the main chamber to drive the cylinder to open or close fluid communication between the main chamber and the top air chamber, the main air valve being fixedly disposed at a top portion of the movable cylinder, wherein:
a valve port is formed between a top valve surface of the fixed main air valve and a bottom valve surface of the cylinder;
an air hole is disposed at the top portion of the cylinder to correspond to the valve port for the fluid communication being performed through the valve port and the air hole; and
a top air tight ring and a bottom air tight ring are disposed on the piston;
such that the piston is disposed at a place to make the valve port and the air hole located between the top and the bottom air tight rings when the cylinder is driven by the high pressure air to move to close the valve port, and the piston is disposed at a place to make the valve port and the air hole located away from the top air tight ring when the cylinder is driven by the high pressure air to move to open the valve port.

8. The main air valve of a nail gun as claimed in claim 7, wherein the main air valve is a fixed valve sleeve.
